(19) United States
(12) Patent Application Publication
(10) Pub. No.: US 2016/0048309 A1
(43) Pub. Date: Feb. 18, 2016

(54) METHOD FOR AUTOMATICALLY CHANGING DISPLAY VERSION OF WEBSITE

(71) Applicant: Gary Kung, Taipei City (TW)

(72) Inventor: Gary Kung, Taipei City (TW)

(73) Assignee: I/O INTERCONNECT INC., Taipei City (TW)

(21) Appl. No.: 14/457,130

(22) Filed: Aug. 12, 2014

(51) Int. Cl. G06F 3/0484; G06F 17/22

(52) U.S. Cl. CPC G06F 3/04847; G06F 17/2247

(57) ABSTRACT

The invention provides a method for automatically switching to a desktop version website when using a display to show an image of a smartphone. The method includes the steps of: a) connecting a docking station with a switch to a smartphone and a display; b) echoing an image from the smartphone onto the display; c) starting an internet connection function of the smartphone; and d) opening a proprietary web browser with a default of displaying a desktop version.

### BACKGROUND OF THE INVENTION

1. Technical Field

The invention relates to displaying of an image of a portable computer such as a smartphone or tablet computer, particularly to displaying of a portable computer whose image is echoed onto a video display.

2. Related Art

Portable computers, such as smartphones and tablet computers, almost become necessary for every person in the world. Many people are involved in surfing internet or networking communication by using portable computers. Also, some users want to echo an image of his or her portable computer onto a large-sized display such as a TV set when he or she is at home or office because the large-sized display is far easier to browse than a portable computer's built-in small-sized screen.

Many websites provide two versions for general users, namely, a desktop version for desktop computers and a smartphone version for portable computers. The desktop version is a normal version including complete information and arrangement, while the smartphone version is a compact version including simplified information and arrangement to fit a compact size of screen of a portable computer. Normally, the selection of website versions is automatic. That is to say, a smartphone version will be automatically selected when a user uses a portable computer to visit a website with two versions. However, a smartphone version will be still automatically selected even if a user has echoed the image onto a large-sized display because the portable computer is still used to connect internet. Although common web browsers installed in portable computers allow changing to the desktop version, it must be performed by a manual operation after the smartphone version has been shown. This really causes inconvenience for users because users must repeatedly change to the smartphone version every time a display is connected to a portable computer. There is no solution to such a problem in the market.

### SUMMARY OF THE INVENTION

An object of the invention is to provide a method for automatically changing display version of website, which can automatically change to a desktop version when a smartphone's image has been echoed onto a display without any manual operation.

To accomplish the above object, the method of the invention includes the steps of: a) connecting a docking station with a switch to a portable computer and a display; b) echoing an image from the portable computer onto the display; c) starting an internet connection function of the portable computer; d) opening a proprietary web browser with a default of displaying a desktop version.

### BRIEF DESCRIPTION OF THE DRAWINGS

FIG. 1 is a schematic view of systematical arrangement of the invention; and

FIG. 2 is a flowchart of the invention.

### DETAILED DESCRIPTION OF THE INVENTION

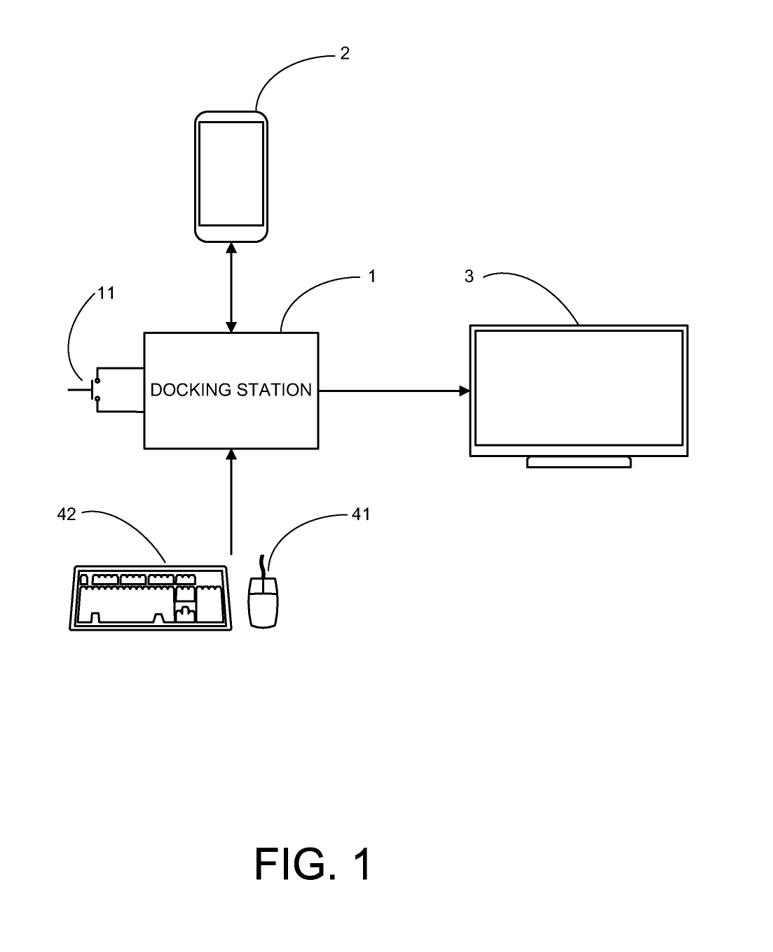

Please refer to FIG. 1. To perform the method of the invention, a docking station 1 is required. A portable computer 2, which can be a smartphone or a tablet computer, is connected to the docking station 1. The connection between the portable computer 2 and the docking station 1 can be wired or wireless. The wired connection can be applied to portable computers which are provided with a micro-HDMI (High-Definition Multimedia Interface) port or a micro-USB port with a built-in mobile audio/video interface such as the Mobile High-Definition Link (MHL) or the Mobility DisplayPort (MyDP) interface. The Miracast standard can be served as the wireless connection. A display 3, which can be a TV set, is connected to the docking station 1 through an HDMI cable. The docking station 1 can transfer audio/video signals from the portable computer 2 to the display 3 so that an image of the portable computer 2 can be echoed onto the display 3 through the docking station 1. Additionally, a mouse 41 and a keyboard 42 may be connected to the docking station 1 for easy operation. The docking station 1 is further provided with a switch 11.

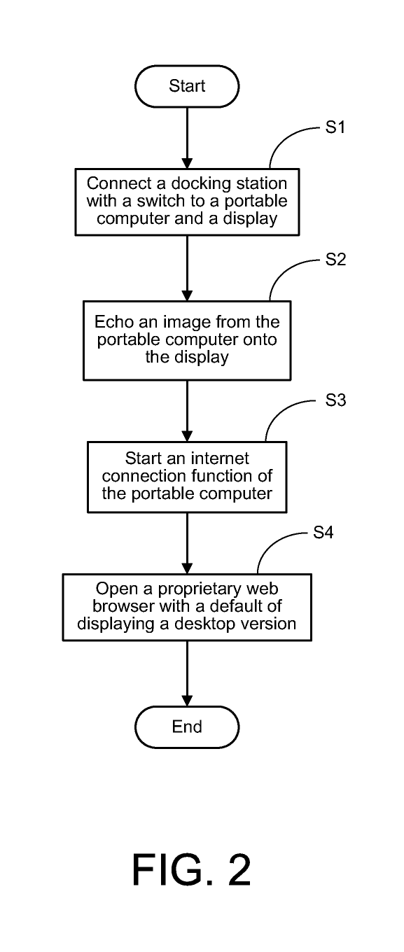

Please refer to FIG. 2, which shows a flowchart of the method of the invention. In step S1, the docking station 1 is connected to the portable computer 2 and the display 3. In step S2, an image of the portable computer 2 is echoed onto the display 3. In step S3, an internet connection function of the portable computer 2 is started. In step S4, a proprietary web browser with a default of displaying a desktop version is opened. The proprietary web browser is an application installed in the portable computer 2 in advance and can be opened by operating the switch 11 of the docking station 1. Of course, the proprietary web browser can also be directly opened by operating the portable computer 2. As a result, the proprietary web browser automatically displays a desktop version of a website. The proprietary web browser always displays a desktop version of a website when each time the proprietary web browser is initially opened.

By implementing the method of the invention, a user can easily and directly browse the desktop version of a website when he or she echoes an image of his or her portable computer onto a display without repeatedly manual operation. This is very useful and helpful for users who connect a portable computer to a large-sized display.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for switching to a desktop version website, comprising the steps of:
a) connecting a docking station with a switch to a portable computer and a display;
b) echoing an image from the portable computer onto the display;
c) starting an internet connection function of the portable computer; and
d) opening a proprietary web browser with a default of displaying a desktop version.

2. The method of claim 1, wherein the docking station is provided with a switch, and the step d) is performed by operating the switch.

3. The method of claim 1, wherein the proprietary web browser is installed in the portable computer.

4. The method of claim 1, wherein the portable computer is a smartphone.

5. The method of claim 1, wherein the portable computer is a tablet computer.
